(19) United States
(12) Patent Application Publication
(10) Pub. No.: US 2003/0225854 A1
(43) Pub. Date: Dec. 4, 2003

(54) Digital rights management system on a virtual private network

(76) Inventors: Peng Zhang, Espoo (FI); Zheng Yan, Espoo (FI); Patric Dahl, Kantvik (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/154,854

(22) Filed: May 28, 2002

(51) Int. Cl. G06F 15/16

(52) U.S. Cl. 709/217

(57) ABSTRACT

The invention is a method and a network providing efficient and controlled DRM of digital rights within one or more VPNs (12). A network (10) in accordance with the invention includes at least one digital rights user (18 and 20), each digital rights user being a user of digital rights, a DRR (30) of the digital rights, a VPN (12), a DRDS (32), coupled to the at least one DRU, and to the storage, which distributes the digital rights to the at least one DRU, and a DRPM (34), coupled to the DRDS which controls providing of the digital rights stored in the DRR to the at least one DRU.

### BACKGROUND OF THE INVENTION

The present invention relates to virtual private networks and, more specifically, to the management of digital rights therein.

### DESCRIPTION OF THE PRIOR ART

Packet data networks, such as the Internet, have become one of the most efficient distribution channels for digital contents or software. However, the characteristics of packet data networks, which make them ideal for distributing digital contents and software, also provide substantial opportunities for misappropriation and misuse of digital contents and software. It is essential to protect digital contents and software in view of the ease with which copying, alteration, defacement and distribution may occur over packet data networks with desktop PCs etc. Digital rights management (DRM) is required to address this problem.

FIG. 1 illustrates a block diagram of virtual private networks (VPN) distributed across a packet data network such as the Internet backbone. As illustrated, VPN-A is connected by tunnels indicated by long dashes which represent secure communications between processors A1, A2 and A3. Similarly, VPN-B is connected by secure tunnels indicated by short dashes between processors B1, B2 and B3.

VPN networks A and B are located in a company or organization which are at different locations. The VPN architecture illustrated in FIG. 1 permits an employee or member of a company or organization to work across the company or organization's local area network (LAN) after connection to the company or organization's VPN by secure tunnels over the backbone packet data network.

Since digital rights and digital contents which include video, audio documents and files are transmitted in and among VPNs, DRM is required for the operation of VPNs, such as illustrated in FIG. 1. The requirement for DRM in and among VPNs has two aspects which are (1) the deploying of VPNs and their applications and (2) the impact that the deploying of DRM has on the backbone in packet data networks such as the Internet.

In practice, DRM and VPN interact in their deployment. For example, a company or organization may need to protect the secrecy of internal digital contents (IDC) which are produced and/or consumed inside a VPN. Another example is when a company or organization sells a product involving digital rights (e.g. licenses to use software) to a customer and wants to monitor the use of the licenses in the customer's VPN. The state of the art today is that DRM in and among VPNs has not been satisfactorily addressed.

Currently, the IDC of a VPN have insufficient digital protection which permits abuses to readily occur. Moreover, in some cases, IDC require a special digital protection inside the VPN such as when only a few top-level managers are permitted to have access to highly confidential documents. Without appropriate digital protection, the highly confidential documents may be easily viewed by other people and flow outside of the VPN.

Limitations on the use of digital rights in VPNs are typically too strict or too loose. For example, an operator of a VPN may wish to purchase a number of licenses of a product from a digital rights issuer and wants the license to be installed in any machine of a VPN. Particularly, the operator does not want the digital rights issuer to know the configuration of the VPN. But the digital rights issuer has to insure that the user obeys the license agreement in the VPN with the digital rights issuer typically providing licenses that can only be installed on specific machines of the user's VPN. The requirement of installation on specific machines necessarily provides the digital rights issuer some information about the user's network. Moreover, if the user wants to move the license from a specific machine to another specific machine, the user has to notify the issuer to get permission. This procedure is not desirable for the user. As a result, the limitations on the use of the digital rights are too strict for the user. On the other hand, the digital rights issuer could try to persuade the user to buy a number of unlimited licenses which can be installed anywhere in the VPN. In this circumstance, the user may agree to the license terms which are likely to be more expensive. But, the digital rights issuer cannot actually explicitly manage the use of the digital rights which means that a greater number of licenses may be installed in the VPN and the licenses could be easily distributed outside the VPN which is representative of the use of digital rights being too loosely controlled.

Often the operator of a VPN fails to efficiently manage the use of digital rights therein especially when the VPN contains a large number of clients and multiple types of digital rights. This leads to a situation for which restrictions on the digital rights are easily disregarded.

### SUMMARY OF THE INVENTION

The present invention is a DRM system within and between VPNs which manages digital rights inside and between VPNs for digital rights users (DRUs) and digital rights issuers. The invention utilizes a Digital Rights Policy Manager (DRPM), a Digital Rights Deployment Server (DRDS), and a Digital Rights Repository (DRR) or storage which are integrated together within the VPN to manage digital rights both internally and externally for DRUs and digital rights issuers. An internal DRU is within the VPN containing the DRPM managing the distribution of the digital rights to the DRU and an external DRU is outside of the VPN containing the DRPM managing the distribution of the digital rights to the DRU. An external DRU may be inside a VPN or external to any VPN and may be connected by a secure link to a VPN which contains internal DRUs.

The digital rights, which are managed by the DRPM, are generated either by the DRPM or are inputted from storage in a DRR of another VPN or an external digital rights source which operates independently of any DRPM. The DRPM controls the storage of digital rights in the DRR. The DRPM creates the digital rights from digital contents and at least one policy controlling digital rights and storage of the created digital rights in the DRR. The digital contents comprise, without limitation, at least one video, audio, documents or files. The digital rights may be created from IDC and consumed by internal DRUs.

The DRPM also generates policies pertaining to managing, creating, recreating, distributing, and use of digital rights. An example, without limitation, the creating and distribution of digital rights may be time based, that is digital rights are issued periodically, e.g. monthly. However, it should be understood that DRPM may be programmed to perform diverse forms of a managing, creating, recreating, distributing and use of digital rights, as well as to generate diverse contents inside the digital rights to indicate how to consume the digital contents in detail.

An internal or external DRU can connect to a DRDS and request downloading of digital rights. To have adequate security, the connection of a DRU to the DRDS requires authentication of the DRU. The authentication may be performed in diverse manners, such as by secure connection or certificates issued to the DRU by a certificate authority (CA) which is either internal or external to the VPN. The internal or external CA provides certificates at the request of the DRUs in accordance with well known procedures which do not form part of the present invention. The DRDS transfers the DRU(s) request for a certificate to the CA and sends the certificate received from the CA to the DRU. In the circumstance of a connection between the DRDS and an external DRU, the connection is secured, such as for example by a tunneling technology such as Secure Sockets Layer (SSL), but it should be understood that the invention is not limited to any particular technology for securing connection. Moreover, a connection between the DRDS and an internal DRU may desirably be made secure depending upon security requirements inside the VPN.

A DRU cannot use digital contents, such as IDC, without being provided the correct digital rights such as a license. The digital rights specify conditions of use, such as where and who can use the digital rights, how long the digital rights can be consumed and what to do after the digital rights are used. The DRU is prevented from abusing the digital rights by the conditions the digital rights specify.

A network in accordance with the invention includes at least one digital rights user with each digital rights user being a user of digital rights; and at least one virtual private network, each virtual private network including a storage of the digital rights, a server, coupled to the at least one digital rights user and to the storage, which distributes the digital rights to the at least one digital rights user, and a digital rights manager, coupled to the server and to the storage, which controls providing of the digital rights stored in the storage to the at least one digital rights user. The at least one digital rights user may be external or internal to the at least one virtual private network. The at least one digital rights user may be plural digital rights users with at least one digital rights user being internal to the at least one virtual private network and at least one digital rights user being external to the at least one virtual private network. Each manager may manage digital contents internal to the network including the digital rights. The digital contents may comprise at least one of video, audio, documents or files. The manager may create the digital rights from the digital contents and at least one policy controlling the digital rights and storage of the created digital rights in the storage. The at least one policy may also comprise conditions pertaining to managing, creating, recreating, use or distributing of the digital rights stored in the storage by the server to the at least one user. A policy may be a set of rules which governs at least one of when, how to create, recreate, distribute, use, or manage the digital rights. The conditions on managing, creating, recreating, use or distributing of the digital rights may be dependent upon a time at which the digital rights are requested by the at least one user. Each user may be authenticated to be a legitimate user of the digital rights by the server prior to distributing of the digital rights to the user. A certificate authority may provide a certificate for each of the at least one user; and wherein the certificate of each of the at least one user may be presented to the server which distributes the digital rights to each user presenting the user's certificate under the control of the manager when the certificate presented by the user authenticates that the user is a legitimate user of the digital rights being requested. The certificate authority may be within or outside the at least one virtual private network. The at least one digital rights user external to the at least one virtual private network may be in another virtual private network and the virtual private networks may be connected together by at least one secure link. A source of external digital rights external to the at least one virtual private network may provide digital rights thereto; and wherein the at least one manager of the at least virtual private network to which the external source of digital rights is coupled may control storage of the digital rights received from the external source of digital rights and providing of the external digital rights to the at least one user. The source of external digital rights may be operated independently of the operation of at least one digital network.

In a network comprising at least one digital rights user with each digital rights user being a user of digital rights and at least one virtual private network including a storage of the digital rights, a server, coupled to the at least one digital rights user and to the storage, which distributes the digital rights to the at least one digital rights user and a digital rights manager, coupled to the server and to the storage, a method of distribution of the digital rights in accordance with the invention includes at least one of the at least one user requests digital rights from the server; and in response to the request from the at least one user, the manager may control providing of the digital rights from the storage to the server which distributes the digital rights to the at least one user requesting the digital rights. The at least one digital rights user may be external or internal to the at least one virtual private network. The at least one digital rights user may be plural digital rights users with at least one digital rights user being internal to the at least one virtual private network and at least one digital rights user being external to the at least one virtual private network. The manager may manage digital contents internal to the network including the digital rights. The digital contents may comprise at least one of video, audio, documents or files. The manager may create the digital rights from the digital contents and at least one policy controlling the digital rights and storage of the created digital rights in the storage. The at least one policy may also comprise conditions pertaining to managing, creating, recreating, use or distributing of the digital rights stored in the storage by the server to the at least one user. A policy may be a set of rules which governs at least one of when, how to create, recreate, distribute, use, or manage the digital rights and what contents should be defined in the digital rights. The conditions on managing, creating, recreating, use or distributing of the digital rights may be dependent upon a time at which the digital rights are requested by the at least one user. Each user may be authenticated to be a legitimate user of the digital rights by the server prior to distributing of the digital rights to the user. A certificate authority may provide a certificate for each of the at least one user; and wherein the certificate of each of the at least one user may be presented to the server which distributes the digital rights to each user presenting the user's certificate under the control of the manager when the certificate presented by the user authenticates that the user is a legitimate user of the digital rights being requested. A source of external digital rights may be external to the at least one virtual private network which provides digital rights thereto; and wherein the at least one manager of the at least virtual private network to which the external source of digital rights is coupled may control storage of the digital rights received from the external source of digital rights and providing of the external digital rights to the at least one user. The certificate authority may be within or external the virtual private network. The source of external digital rights may be operated independently of the operation of at least one digital network.

In a network comprising at least one digital rights user with each digital rights user being a user of digital rights and a digital rights issuer virtual private network which issues the digital rights and a digital rights user virtual private network containing the at least one digital rights user, each virtual private network including a storage of the digital rights, a server, coupled to the at least one digital rights user and to the storage, which distributes the digital rights to the at least one digital rights user and a digital rights manager, coupled to the server and to the storage, a method of distribution of the digital rights in accordance with the invention includes at least one of the at least one user requests digital rights from the server of the digital rights user virtual private network; the digital rights manager of the digital rights user virtual private network requests the digital rights from the digital rights issuer virtual private network; the digital rights issuer virtual private network transmits the digital rights to the digital rights user virtual private network; and the digital rights user virtual private network transmits the digital rights to the at least one user of digital rights. The digital rights user virtual private network may in response to receipt of the digital rights from the digital rights issuer virtual private network transmit the digital rights from the digital rights manager to the storage, from the storage to the server and from the server to the at least one user of digital rights. The digital rights issuer virtual private network may, in response to the request for digital rights, transmit the request from the server to the manager which creates the digital rights; the digital rights created by the manager are transmitted from the manager to the storage; the digital rights may transmitted from the storage to the server; and the digital rights may be transmitted from the server to the manager of the digital rights user virtual private network.

### BRIEF DESCRIPTION OF THE DRAWINGS

FIG. 1 illustrates a diagram of a prior art VPN of the type in which the present invention may be practiced.

FIG. 2 illustrates a block diagram of a network including VPNs in accordance with the present invention.

FIG. 3 illustrates a network in accordance with the invention having a digital rights issuer VPN and a user VPN in accordance with the present invention.

FIG. 4 illustrates operation of a VPN in accordance with the invention which distributes digital rights to an internal DRU.

FIG. 5 illustrates the operation of the network in accordance with FIG. 3.

Like reference numerals identify like parts throughout the drawings.

### DESCRIPTION OF THE PREFERRED EMBODIMENTS

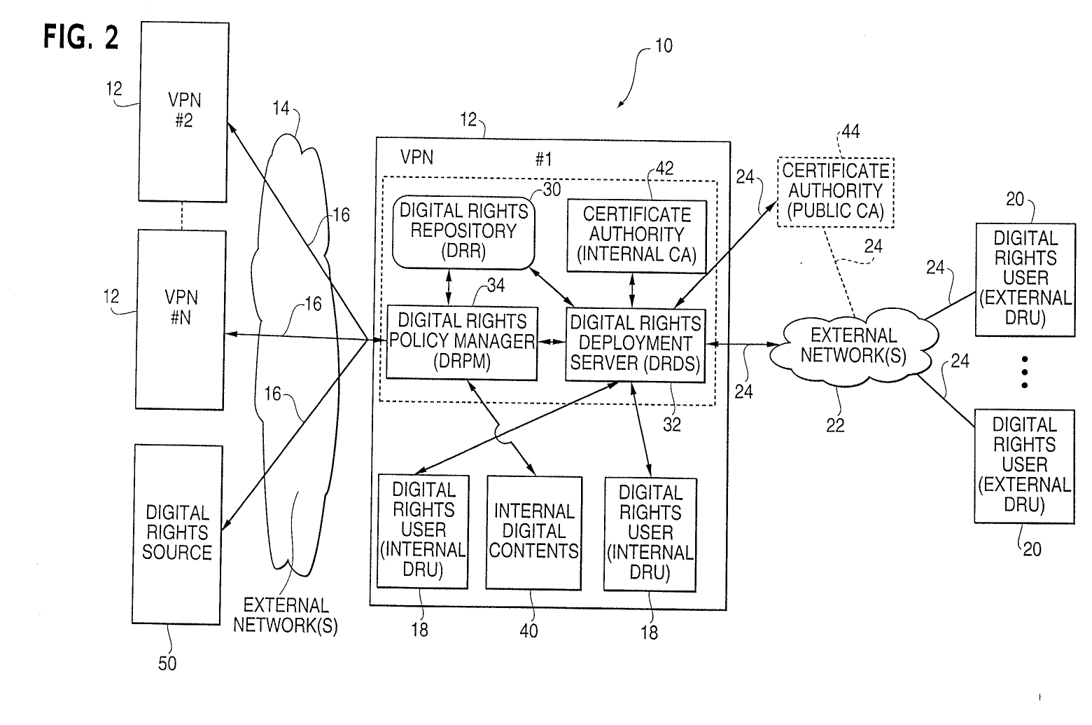

FIG. 2 illustrates a network 1 0 in accordance with the present invention. The network 10 is comprised of a group (#s 1-N) VPNs 12 which are used in the practice of the present invention. The VPNs 12 are interconnected through a packet data network 14 which may be of any known design, such as the Internet, via secure tunnels 16.

The network 10 performs the distribution of digital rights between DRUs which are either internal DRUs 18 which are located within a VPN 12 having a DRPM 34 which controls the distribution of the digital rights or are external DRUs 20 which are inside of another VPN 12 or are external to any VPN and are connected via external networks 22 to the VPN 12 having a DRPM 34 which controls the distribution of the digital rights. The connectivity between DRUs 20, which are external to a VPN having the DRPM 34 which controls the distribution of the digital rights, is via secure links 24 which may use any known security measure such as, without limitation, Secure Sockets Layer (SSL).

The DRM provided by the present invention is described with reference to FIG. 2 principally with reference to the #1 VPN 12. However, it should be understood that the #s 2-N VPNs 12 may have the same architecture. Each VPN 12 may contain at least one internal DRU 18. The DRR 30 stores digital rights which are used by the internal DRUs 18 and the external DRUs 20. A DRDS 32 is coupled to the DRR 30 and the DRPM and distributes the digital rights to at least one internal DRU 18 or external DRU 20 under control of the DRPM 34.

The DRPM 34 performs multiple functions in the providing of DRM. First, the DRPM 34 controls providing of the digital rights stored in the DRR 30 through the DRDS 32 to the internal and external DRUs 18 and 20. Second, the DRPM 34 creates digital rights from digital contents such as, but not limited to, IDC 40 which may be without limitation audio, video, documents or files contained anywhere within the VPN 12 or from an external source of digital contents. Third, the DRPM 34 establishes and implements at least one policy controlling digital rights. Finally, the at least one policy comprises conditions pertaining to managing, creating, recreating, use or distributing of the digital rights.

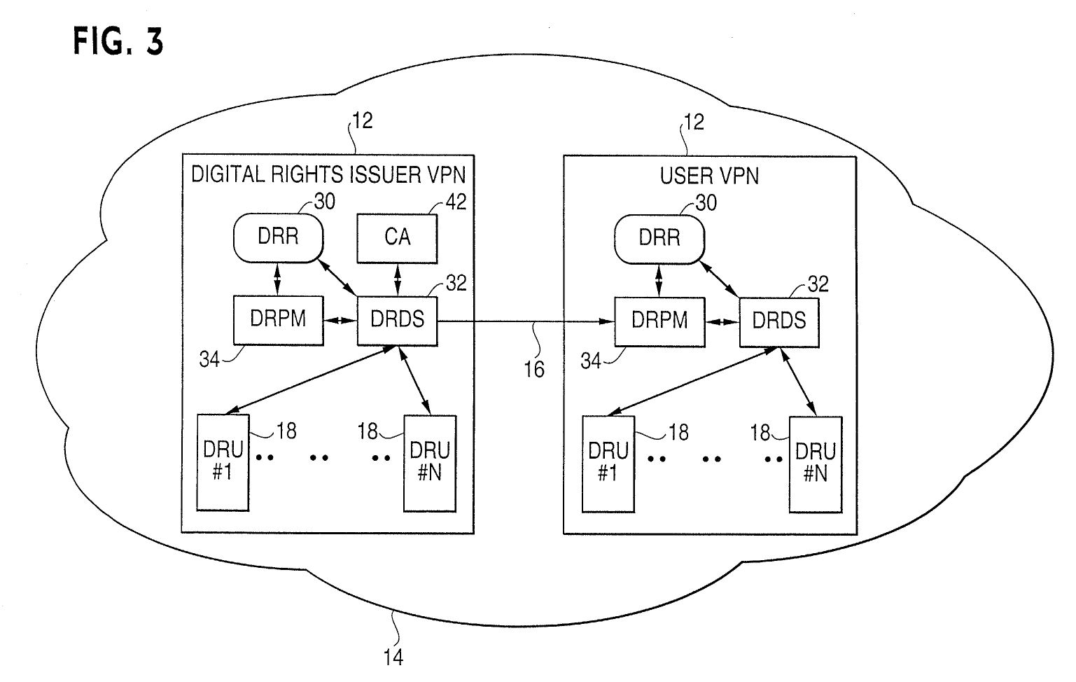

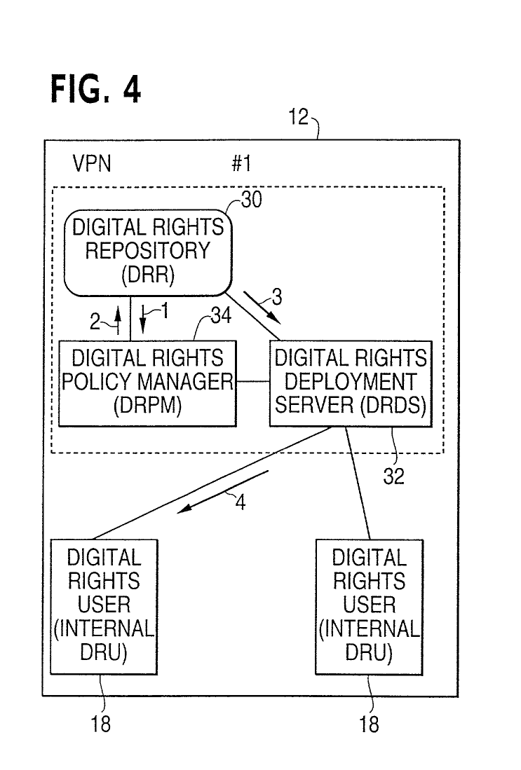

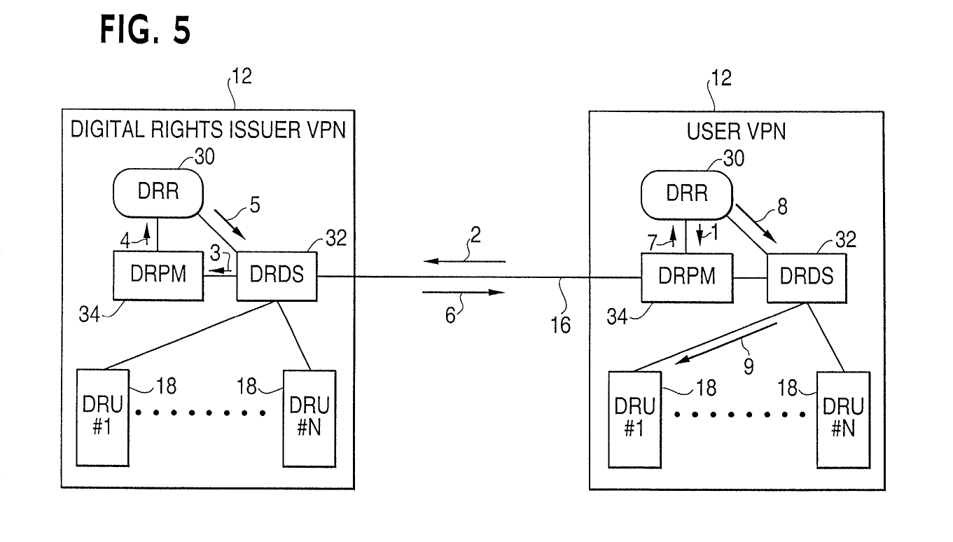

The distributing of digital rights by the DRPM 34 is a control function which includes controlling the conditions of how and when digital rights are provided from storage in the DRR 30 to the DRDS 32 from which they are distributed after authentication of the requesting DRU to either the internal DRUs 18 or the external DRUs 20. In a push operation, as described below with reference to FIGS. 3 and 4 involving consumption of digital rights, either an internal DRU 18 or an external DRU 20 connects to the DRDS and requests the downloading of digital rights to the requesting DRU 18 or 20. In a pull operation of digital rights, as described below with reference to FIG. 5, from a digital rights issuer VPN 12 to an external DRU 20 in a user VPN 12, the user VPN sends a request to the DRPM 34 for the digital rights.

The connection of either an internal DRU 18 or an external DRU 20 to the DRDS 32 providing the digital rights requires authentication. Authentication is performed by the DRDS 32 at the time of the requesting of digital rights by security measures, such as the use of encryption or presenting of a valid certificate in the form of a public key or any other known authentication mechanism.

When certificates are used for authentication, the DRDS 32 authenticates the individual DRUs 18 and DRUs 20, which are requesting digital rights, by use of either the internal certificate authority 42 or an external certificate authority 44. As long as the requesting DRU 18 or 20 presents a valid certificate and a valid digital signature, which is verified by the public key obtained from a CA, the authentication is completed. This authentication procedure is based on public key infrastructure. Therefore matching public key, the private key stored in each DRU 18 which was obtained from a CA, permits authentication to be completed.

When the DRUs 18 or 20 send a request, the DRU attaches the certificate thereof (containing the public key) and a digital signature (which is signed the DRU private key) to the request. The DRDS 32 receives the request and verifies the digital signature with the presented certificate (i.e. the public key). If the verification passes, the DRU is authenticated beforehand the DRDS 32 necessarily connects to a CA to make sure the certificate sent by the DRU is a valid certificate (e.g. not expired). This authentication procedure is based on public key infrastructure.

The digital rights stored in the DRR 30, as described above, are typically created from the IDC 40 by the DRPM 34. However, alternatively, digital rights which are stored in the DRR 30 may be obtained from the #2-N VPNs 12 or from an independent digital rights source 50 which may be any digital rights distributing entity which licenses, creates, or otherwise provides digital rights independent of any DRPM 34 for storage in the DRR 30.

The digital rights stored in the DRR 30 have associated conditions of use. The conditions of use are without limitation where and who may use the digital rights, how long the digital rights can be used, and what happens after the digital rights are used. The conditions of use prevent the DRUs 18 and 20 from abusing the digital rights as defined and stored in the DRR 30.

The present invention has many benefits. Digital rights management is combined with the VPN secure management and network operation. The digital rights issuer works with the DRPM 34 to generate and control digital rights consumption by DRUs 18 and 20. The operators of VPNs are provided the ability to manage the digital rights through working with the DRPM 34 and to distribute the digital rights to clients over the VPNs. The IDC 40 associated with the digital rights stored in the DRR 30 are protected inside and between VPNs 12.

The network of the invention provides operation under diverse circumstances. First, the issuers of digital rights, such as the digital rights source 50 and the DRUs 20 do not have to have a VPN. Second, the digital rights source does not have to be associated with a VPN, such as the independent digital rights source 50 being separated from all VPNs, and at least some of the DRUs are within the VPN 12 such as the DRUs 18. Third, the digital rights issuer may be within a VPN with the DRPM 34 controlling the storage, creation, recreation, distribution, and conditions of use, etc. of the digital rights while the DRUs are only external DRUs 20 (this situation exists when there are no DRUs 18 in the VPN). Finally, a digital rights issuer may be associated with a VPN 12 and at least some of the DRUs are internal DRUs 18.

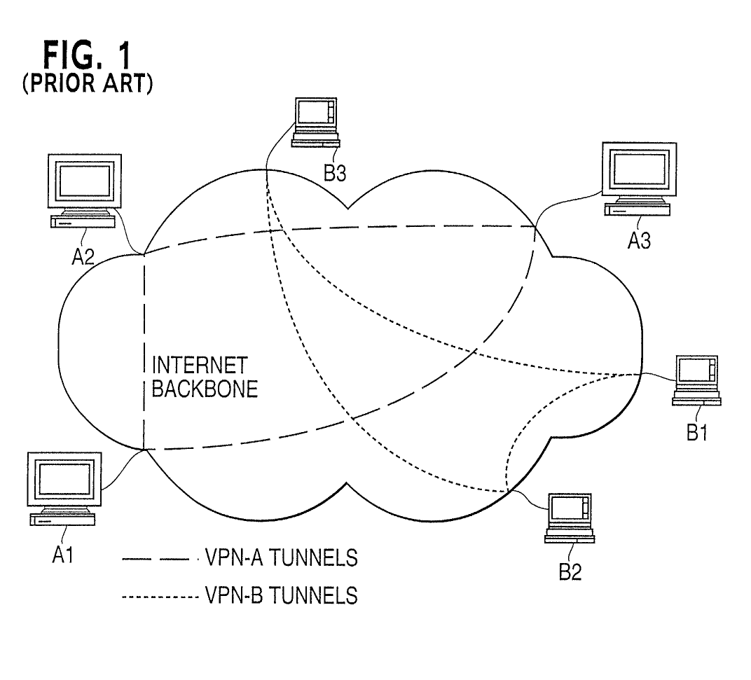

The present invention may be practiced such that not all VPNs contain all of the entities of the #1 VPN 12 of FIG. 2. Moreover, deployment of the present invention is a simple matter which utilizes existing VPNs such as in the prior art of FIG. 1.

FIG. 3 illustrates an example of digital rights distribution between two VPNs 12 in accordance with the invention. The digital rights issuer VPN 12 functions as a source of digital rights to a user VPN 12. As illustrated, the digital rights stored in the DRR 30 of the digital rights issuer VPN 12 are retrieved under control of the DRPM 34 of the digital rights issuer VPN from storage in the DRR 30 and distributed by the DRDS 32 over a secure link 16 in network 14 to the DRPM 34 of the user VPN. The digital rights are stored in the DRR 30 of the user VPN 12 for consumption by the DRUs of the user VPN when received by the DRDS 32 of the user VPN under the control of the DRPM of the digital rights issuer VPN.

The digital rights stored in the DRR 30 of the user VPN 12 are retrieved under the control of the DRDS 32 after a requesting DRU 18 in the user VPN 12 has been authenticated by any known authentication mechanism. As illustrated, the CA 42 of the digital rights issuer VPN 12 generates certificates used for authentication of each of the DRUs 18 in the digital rights issuer and user VPNs. The DRPM 34 of the digital rights issuer VPN generates and manages digital rights for the DRUs 18 internal to the digital rights issuer VPN 12 and for the actual DRUs 18 within the user VPN 12 which are external to the digital rights issuer VPN. The DRPM 34 of the digital rights issuer VPN generates and manages the digital rights for protecting the IDC (not illustrated) of the digital rights issuer VPN. The DRPM 34 of the user VPN 12 generates and manages the digital rights protecting the IDC of the user VPN. It is therefore seen that the digital rights issuer VPN provides digital rights to the group of DRUs 18 in the user VPN 12.

FIG. 4 illustrates operation of a VPN for a push operation in accordance with the invention which distributes digital rights to internal DRUs 18. The first step is the DRR 30 sends the DRPM 34 a request for regeneration of digital rights with regeneration occurring based upon the current requesting internal DRU digital rights exploration time. For the second step, the DRPM 34, which controls the digital rights generation/regeneration policies, generates digital rights for the internal DRU 18 based on the rights and generation policies and stores the digital rights in the DRR 30. For the third step, the DRR 30 transmits the digital rights to the DRDS 32. After authentication, the DRDS 32 transmits the digital rights to the internal DRU 18.

FIG. 5 illustrates the operation of the network in accordance with FIG. 3 involving the pulling of digital rights from a digital rights issuer VPN to an external DRU in a user VPN. At step 1, the DRR of the user VPN sends a request to the DRPM 34 for regeneration of digital rights (based on e.g., the current requesting internal DRU 18 digital rights exploration time). At step 2, the DRPM 34 of the issuer VPN forwards the request to the DRDS of the issuer VPN. At the third step, the DRDS 32 of the issuer VPN 12 forwards the request to the DRPM 34 thereof. At the fourth step, the DRPM 34 of the issuer VPN 12 (which holds the digital rights and regeneration policies for the digital rights issuer VPN) generates digital rights for the external DRU 18 of the user VPN based on the digital rights generation policies and stores the digital rights in the DRR 30 of the digital rights issuer VPN. At step 5, the DRR 30 of the issuer VPN 12 transmits the digital rights to the DRDS 32 of the digital rights issuer VPN 12. At step 6, the DRDS 32 of the issuer VPN 12 sends the digital rights to the DRPM 34 of the user VPN 12. At step 7, the DRPM 34 of the user VPN 30 causes storage of the digital rights in a DRR 30 of the user VPN 12. At step 8, the DRR 30 of the user VPN 12 transmits the digital rights to the DRDS 32 of the user VPN. At step 9, after authentication of the DRU 18 in the user VPN which is requesting the digital rights, the DRDS 32 of the user VPN 12 sends the digital rights to the DRU 18 therein.

As an alternative, the DRPM 34 of the user VPN can also issue new digital rights instead of the DRPM 34 of the issuer VPN to save communication costs. In this circumstance, steps 2-6 are not necessary.

The implementation of the DRR 30, DRDS 32 and DRPM may be implemented in diverse ways. For example, a single processor and associated memory may implement the DRR 30, DRDS 32 and DRPM 34 by suitable programming which does not form part of the present invention.

While the invention has been described in terms of the preferred embodiments, it should be understood that numerous modifications may be made thereto without departing from the spirit and scope of the present invention. It is intended that all such modifications fall within the scope of the appended claims.

1. A network comprising:
at least one digital rights user with each digital rights user being a user of digital rights; and
at least one virtual private network, each virtual private network including a storage of the digital rights, a server, coupled to the at least one digital rights user and to the storage, which distributes the digital rights to the at least one digital rights user, and a digital rights manager, coupled to the server and to the storage, which controls providing of the digital rights stored in the storage to the at least one digital rights user.

2. A network in accordance with claim 1 wherein:
the at least one digital rights user is external to the at least one virtual private network.

3. A network in accordance with claim 1 wherein:
the at least one digital rights user is internal to the at least one virtual private network.

4. A network in accordance with claim 1 wherein:
the at least one digital rights user are plural digital rights users with at least one digital rights user being internal to the at least one virtual private network and at least one digital rights user being external to the at least one virtual private network.

5. A network in accordance with claim 1 wherein:
each manager manages digital contents internal to the network including the digital rights.

6. A network in accordance with claim 2 wherein:
each manager manages digital contents internal to the network including the digital rights.

7. A network in accordance with claim 3 wherein:
each manager manages digital contents internal to the network including the digital rights.

8. A network in accordance with claim 4 wherein:
each manager manages digital contents internal to the network including the digital rights.

9. A network in accordance with claim 1 wherein:
the digital contents comprise at least one of video, audio, documents or files.

10. A network in accordance with claim 5 wherein:
the manager creates the digital rights from the digital contents and at least one policy controlling the digital rights and storage of the created digital rights in the storage.

11. A network in accordance with claim 6 wherein:
the manager creates the digital rights from the digital contents and at least one policy controlling issuing of digital rights and controls storage of the created digital rights in the storage.

12. A network in accordance with claim 7 wherein:
the manager creates the digital rights from the digital contents and at least one policy controlling the digital rights and storage of the created digital rights in the storage.

13. A network in accordance with claim 8 wherein:
the manager creates the digital rights from the digital contents and at least one policy controlling the digital rights and storage of the created digital rights in the storage.

14. A network in accordance with claim 10 wherein:
the at least one policy also comprises conditions pertaining to managing, creating, recreating, use or distributing of the digital rights stored in the storage by the server to the at least one user.

15. A network in accordance with claim 11 wherein:
the at least one policy also comprises conditions pertaining to managing, creating, recreating, use or distributing of the digital rights stored in the storage by the server to the at least one user.

16. A network in accordance with claim 12 wherein:
the at least one policy also comprises conditions pertaining to managing, creating, recreating, use or distributing of the digital rights stored in the storage by the server to the at least one user.

17. A network in accordance with claim 13 wherein:
the at least one policy also comprises conditions pertaining to managing, creating, recreating, use or distributing of the digital rights stored in the storage by the server to the at least one user.

18. A network in accordance with claim 10 wherein:
a policy is a set of rules which governs at least one of when, how to create, recreate, distribute, use, manage the digital rights and what usage conditions should be included in the digital rights.

19. A network in accordance with claim 14 wherein:
the conditions on managing, creating, recreating, use or distributing of the digital rights are dependent upon a time at which the digital rights are requested by the at least one user.

20. A network in accordance with claim 15 wherein;
the conditions on managing, creating, recreating, use or distributing of the digital rights are dependent upon a time at which the digital rights are requested by the at least one user.

21. A network in accordance with claim 16 wherein;
the conditions on managing, creating, recreating, use or distributing of the digital rights are dependent upon a time at which the digital rights are requested by the at least one user.

22. A network in accordance with claim 17 wherein;
the conditions on managing, creating, recreating, use or distributing of the digital rights are dependent upon a time at which the digital rights are requested by the at least one user.

23. A network in accordance with claim 1 wherein:
each user is authenticated to be a legitimate user of the digital rights by the server prior to distributing of the digital rights to the user.

24. A network in accordance with claims 1 comprising:
a certificate authority which provides a certificate for each of the at least one user; and wherein
the certificate of each of the at least one user is presented to the server which distributes the digital rights to each user presenting the user's certificate under the control of the manager when the certificate presented by the user authenticates that the user is a legitimate user of the digital rights being requested.

25. A network in accordance with claim 24 wherein:
the certificate authority is within the at least one virtual private network.

26. A network in accordance with claim 24 wherein:
the certificate authority is outside the at least one virtual private network.

27. A network in accordance with claim 2 wherein:
the at least one digital rights user external to the at least one virtual private network is in another virtual private network and the virtual private networks are connected together by at least one secure link.

28. A network in accordance with claim 4 wherein:
the at least one digital rights user external to the at least one virtual private network is in another virtual private network and the virtual private networks are connected together by at least one secure link.

29. A network in accordance with claim 1 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

30. A network in accordance with claim 2 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

31. A network in accordance with claim 3 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

32. A network in accordance with claim 4 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

33. A network in accordance with claim 5 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

34. A network in accordance with claim 10 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

35. A network in accordance with claim 14 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

36. A network in accordance with claim 19 comprising:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

37. A network in accordance with claim 29 wherein:
the source of external digital rights is operated independently of the operation of at least one digital network.

38. In a network comprising at least one digital rights user with each digital rights user being a user of digital rights and at least one virtual private network including a storage of the digital rights, a server, coupled to the at least one digital rights user and to the storage, which distributes the digital rights to the at least one digital rights user and a digital rights manager, coupled to the server and to the storage, a method of distribution of the digital rights comprising:
at least one of the at least one user requests digital rights from the server; and
in response to the request from the at least one user, the manager controls providing of the digital rights from the storage to the server which distributes the digital rights to the at least one user requesting the digital rights.

39. A method in accordance with claim 38 wherein:
the at least one digital rights user is external to the at least one virtual private network.

40. A method in accordance with claim 38 wherein:
the at least one digital rights user is internal to the at least one virtual private network.

41. A method in accordance with claim 38 wherein:
the at least one digital rights user are plural digital rights users with at least one digital rights user being internal to the at least one virtual private network and at least one digital rights user being external to the at least one virtual private network.

42. A method in accordance with claim 38 comprising:
the manager manages digital contents internal to the network including the digital rights.

43. A method in accordance with claim 39 comprising:
the manager manages digital contents internal to the network including the digital rights.

44. A method in accordance with claim 40 comprising:
the manager manages digital contents internal to the network including the digital rights.

45. A method in accordance with claim 41 comprising:
the manager manages digital contents internal to the network including the digital rights.

46. A method in accordance with claim 42 wherein:
the digital contents comprise at least one of video, audio, documents or files.

47. A method in accordance with claim 42 comprising:
the manager creates the digital rights from the digital contents and at least one policy controlling the digital rights and storage of the created digital rights in the storage.

48. A method in accordance with claim 43 comprising:
the manager creates the digital rights from the digital contents and at least one policy controlling the digital rights and storage of the created digital rights in the storage.

49. A method in accordance with claim 44 comprising:
the manager creates the digital rights from the digital contents and at least one policy controlling the digital rights and storage of the created digital rights in the storage.

50. A method in accordance with claim 45 comprising:
the manager creates the digital rights from the digital contents and at least one policy controlling the digital rights and storage of the created digital rights in the storage.

51. A method in accordance with claim 47 comprising:
the at least one policy also comprises conditions pertaining to managing, creating, recreating, use or distributing of the digital rights stored in the storage by the server to the at least one user.

52. A method in accordance with claim 48 comprising:
the at least one policy also comprises conditions pertaining to managing, creating, recreating, use or distributing of the digital rights stored in the storage by the server to the at least one user.

53. A method in accordance with claim 49 comprising:
the at least one policy also comprises conditions pertaining to managing, creating, recreating, use or distributing of the digital rights stored in the storage by the server to the at least one user.

54. A method in accordance with claim 50 comprising:
the at least one policy also comprises conditions pertaining to managing, creating, recreating, use or distributing of the digital rights stored in the storage by the server to the at least one user.

55. A method in accordance with claim 51 wherein:
a policy is a set of rules which governs at least one of when, how to create, recreate, distribute, use, manage the digital rights and what usage conditions should be included in the digital rights.

56. A method in accordance with claim 51 comprising:
the conditions on managing, creating, recreating, use or distributing of the digital rights are dependent upon a time at which the digital rights are requested by the at least one user.

57. A method in accordance with claim 52 comprising:
the conditions on managing, creating, recreating, use or distributing of the digital rights are dependent upon a time at which the digital rights are requested by the at least one user.

58. A method in accordance with claim 53 comprising:
the conditions on managing, creating, recreating, use or distributing of the digital rights are dependent upon a time at which the digital rights are requested by the at least one user.

59. A method in accordance with claim 54 comprising:
the conditions on managing, creating, recreating, use or distributing of the digital rights are dependent upon a time at which the digital rights are requested by the at least one user.

60. A method in accordance with claim 38 comprising:
each user is authenticated to be a legitimate user of the digital rights by the server prior to distributing of the digital rights to the user.

61. A method in accordance with claim 38 comprising:
a certificate authority which provides a certificate for each of the at least one user; and wherein
the certificate of each of the at least one user is presented to the server which distributes the digital rights to each user presenting the user's certificate under the control of the manager when the certificate presented by the user authenticates that the user is a legitimate user of the digital rights being requested.

62. A method in accordance with claim 38 wherein:
a source of external digital rights external to the at least one virtual private network which provides digital rights thereto; and wherein
the at least one manager of the at least virtual private network to which the external source of digital rights is coupled controls storage of the digital rights received from the external source of digital rights and providing of the external digital rights to the at least one user.

63. A method in accordance with claim 62 comprising:
the certificate authority is within the virtual private network.

64. A method in accordance with claim 62 comprising:
the certificate authority is external the virtual private network.

65. A method in accordance with claim 64 comprising:
the source of external digital rights is operated independently of the operation of at least one digital network.

66. In a network comprising at least one digital rights user with each digital rights user being a user of digital rights and a digital rights issuer virtual private network which issues the digital rights and a digital rights user virtual private network containing the at least one digital rights user, each virtual private network including a storage of the digital rights, a server, coupled to the at least one digital rights user and to the storage, which distributes the digital rights to the at least one digital rights user and a digital rights manager, coupled to the server and to the storage, a method of distribution of the digital rights comprising:
at least one of the at least one user requests digital rights from the server of the digital rights user virtual private network;
the digital rights manager of the digital rights user virtual private network requests the digital rights from the digital rights issuer virtual private network;
the digital rights issuer virtual private network transmits the digital rights to the digital rights user virtual private network; and
the digital rights user virtual private network transmits the digital rights to the at least one user of digital rights.

67. A method in accordance with claim 66 wherein:
the digital rights user virtual private network in response to receipt of the digital rights from the digital rights issuer virtual private network transmits the digital rights from the digital rights manager to the storage, from the storage to the server and from the server to the at least one user of digital rights.

68. A method in accordance with claim 66 wherein:
the digital rights issuer virtual private network, in response to the request for digital rights, transmits the request from the server to the manager which creates the digital rights;
the digital rights created by the manager are transmitted from the manager to the storage;
the digital rights are transmitted from the storage to the server; and
the digital rights are transmitted from the server to the manager of the digital rights user virtual private network.

69. A method in accordance with claim 67 wherein:
the digital rights issuer virtual private network, in response to the request for digital rights, transmits the request from the server to the manager which creates the digital rights;
the digital rights created by the manager are transmitted from the manager to the storage;
the digital rights are transmitted from the storage to the server; and
the digital rights are transmitted from the server to the manager of the digital rights user virtual private network.
